(19) United States
(12) Patent Application Publication
(10) Pub. No.: US 2024/0256635 A1
(43) Pub. Date: Aug. 1, 2024

(54) FREQUENCY DISTRIBUTION DATA GENERATION DEVICE, FREQUENCY DISTRIBUTION DATA GENERATION METHOD, AND RECORDING MEDIUM

(71) Applicant: NEC Corporation, Tokyo (JP)

(72) Inventor: Kazuhisa Ishizaka, Tokyo (JP)

(73) Assignee: NEC Corporation, Tokyo (JP)

(21) Appl. No.: 18/423,545

(22) Filed: Jan. 26, 2024

(30) Foreign Application Priority Data
Feb. 1, 2023 (JP) 2023-013923

(51) Int. Cl. G06F 17/18

(52) U.S. Cl. CPC G06F 17/18

(57) ABSTRACT

A frequency distribution data generation device includes: a memory configured to store instructions; and a processor configured to execute the instructions to: estimate whether or not a number of intervals that are included in frequency distribution data at a time when all numbers included in a numerical sequence are reflected, is greater than a predetermined threshold, each interval having an interval width, the frequency distribution data indicating, for each of the intervals, a number of numbers included in the interval among numbers included in the numerical sequence; change the interval width to a wider interval width when the number of the intervals is estimated to be greater than the threshold value; and generate the frequency distribution data with the changed interval width.

### CROSS-REFERENCE TO RELATED APPLICATIONS

This application is based upon and claims the benefit of priority from Japanese patent application No. 2023-013923, filed on Feb. 1, 2023, the disclosure of which is incorporated herein in its entirety by reference.

### TECHNICAL FIELD

The present disclosure relates to a frequency distribution data generation device, a frequency distribution data generation method, and a recording medium.

### BACKGROUND ART

There are cases where data indicating the frequency distribution of numbers included in a numerical sequence is generated. For example, Japanese Unexamined Patent Application, First Publication No. 2012-247866 discloses that when performing radix sorting on an M-bit integer sequence, a histogram of the appearance frequency of the bit positions of the upper K bits of the sorting target integer sequence is created.

### SUMMARY

When generating data indicating the frequency distribution of numbers included in a numerical sequence, it is preferable that data indicating the frequency distribution of interval widths corresponding to the numerical sequence be generated in as short a time as possible.

An example object of the present disclosure is to provide a frequency distribution data generation device, a frequency distribution data generation method, and a recording medium capable of solving the above problem.

According to a first example aspect of the present disclosure, a frequency distribution data generation device includes: a memory configured to store instructions; and a processor configured to execute the instructions to: estimate whether or not a number of intervals that are included in frequency distribution data at a time when all numbers included in a numerical sequence are reflected, is greater than a predetermined threshold, each interval having an interval width, the frequency distribution data indicating, for each of the intervals, a number of numbers included in the interval among numbers included in the numerical sequence; change the interval width to a wider interval width when the number of the intervals is estimated to be greater than the threshold value; and generate the frequency distribution data with the changed interval width.

According to a second example aspect of the present disclosure, a frequency distribution data generation method executed by a computer includes: estimating whether or not a number of intervals that are included in frequency distribution data at a time when all numbers included in a numerical sequence are reflected, is greater than a predetermined threshold, each interval having an interval width, the frequency distribution data indicating, for each of the intervals, a number of numbers included in the interval among numbers included in the numerical sequence; changing the interval width to a wider interval width when the number of the intervals is estimated to be greater than the threshold value; and generating the frequency distribution data with the changed interval width.

According to a third example aspect of the present disclosure, a non-transitory computer-readable recording medium stores a program for causing a computer to execute: estimating whether or not a number of intervals that are included in frequency distribution data at a time when all numbers included in a numerical sequence are reflected, is greater than a predetermined threshold, each interval having an interval width, the frequency distribution data indicating, for each of the intervals, a number of numbers included in the interval among numbers included in the numerical sequence; changing the interval width to a wider interval width when the number of the intervals is estimated to be greater than the threshold value; and generating the frequency distribution data with the changed interval width.

According to the present disclosure, when generating data indicating the frequency distribution of numbers included in a numerical sequence, it is possible in a relatively short time to generate data indicating the frequency distribution of interval widths corresponding to the numerical sequence.

### BRIEF DESCRIPTION OF THE DRAWINGS

FIG. 1 is a diagram showing an example of a configuration of a frequency distribution data generation device according to some example embodiments of the present disclosure.

FIG. 2 is a diagram showing an example of allocating sort-target integers to cores.

FIG. 3 is a diagram showing an example of frequency distribution data in the form of a hash table, according to some example embodiments of the present disclosure.

FIG. 4 is a diagram showing an example of frequency distribution data in the form of a hash table that includes no intervals in which the number of numbers included in input data is zero, according to some example embodiments of the present disclosure.

FIG. 5 is a diagram showing an example of frequency distribution data having a relatively narrow interval width.

FIG. 6 is a diagram showing a first example of changing frequency distribution data in the process of generating frequency distribution data by means of the frequency distribution data generation device according to some example embodiments of the present disclosure.

FIG. 7 is a diagram showing a second example of changing frequency distribution data in the process of generating frequency distribution data by means of the frequency distribution data generation device according to some example embodiments of the present disclosure.

FIG. 8 is a diagram showing a third example of changing frequency distribution data in the process of generating frequency distribution data by means of the frequency distribution data generation device according to some example embodiments of the present disclosure.

FIG. 9 is a diagram showing a fourth example of changing frequency distribution data in the process of generating frequency distribution data by means of the frequency distribution data generation device according to some example embodiments of the present disclosure.

FIG. 10 is a diagram showing a fifth example of changing frequency distribution data in the process of generating frequency distribution data by means of the frequency distribution data generation device according to some example embodiments of the present disclosure.

FIG. 11 is a diagram showing a first example of a key calculated by means of masking on a bit sequence performed by a frequency distribution data generation unit according to some example embodiments of the present disclosure.

FIG. 12 is a diagram showing a second example of a key calculated by means of masking on a bit sequence performed by the frequency distribution data generation unit according to some example embodiments of the present disclosure.

FIG. 13 is a diagram showing a third example of a key calculated by means of masking on a bit sequence performed by the frequency distribution data generation unit according to some example embodiments of the present disclosure.

FIG. 14 is a diagram showing an example of keys calculated by means of a shift operation performed by the frequency distribution data generation unit according to some example embodiments of the present disclosure.

FIG. 15 is a diagram showing an example of a processing procedure of frequency distribution data generation performed by the frequency distribution data generation device according to some example embodiments of the present disclosure.

FIG. 16 is a diagram showing an example of a processing procedure in which the frequency distribution data generation unit according to some example embodiments of the present disclosure changes frequency distribution data of before interval width change to frequency distribution data of after interval width change.

FIG. 17 is a diagram showing an example of another configuration of the frequency distribution data generation device according to some example embodiments of the present disclosure.

FIG. 18 is a diagram showing an example of a processing procedure in a frequency distribution data generation method according to some example embodiments of the present disclosure.

FIG. 19 is a schematic block diagram showing a configuration of a computer according to at least one of example embodiments.

### EXAMPLE EMBODIMENT

Hereinafter, example embodiments of the present disclosure will be described, however, the present disclosure within the scope of the claims is not limited by the following example embodiments. Furthermore, not all of the combinations of features described in the example embodiments are essential for the solving means of the disclosure.

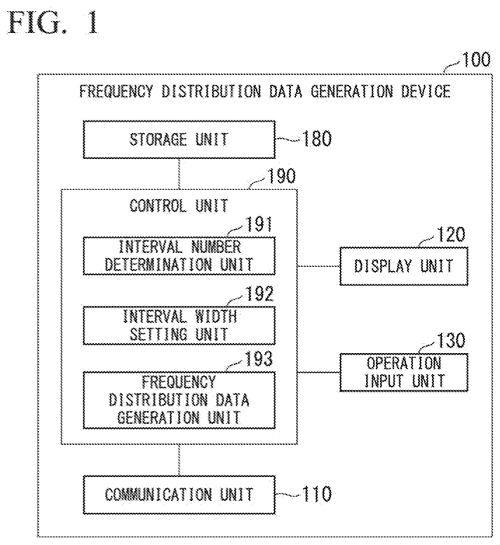

FIG. 1 is a diagram showing an example of a configuration of a frequency distribution data generation device according to some example embodiments of the present disclosure. In the configuration shown in FIG. 1, the frequency distribution data generation device 100 includes a communication unit 110, a display unit 120, an operation input unit 130, a storage unit 180, and a control unit 190. The control unit 190 includes an interval number determination unit 191, an interval width setting unit 192, and a frequency distribution data generation unit 193.

The frequency distribution data generation device 100 generates frequency distribution data of numbers included in the numerical sequence obtained as input data. The frequency distribution data referred to here is data indicating, for each interval of a set interval width, the number of numbers included in the interval among the numbers included in the numerical sequence. The frequency distribution data corresponds to an example of data indicating the frequency distribution of numbers in a numerical sequence.

An interval in frequency distribution data is also referred to as a class interval. The numbers included in the numerical sequence that the frequency distribution data generation device 100 acquires as input data, are also simply referred to as numbers included in input data.

In the following, a case will be described as an example in which the frequency distribution data generation device 100 generates frequency distribution data for allocating integers included in a sorting-target numerical sequence to each core as evenly as possible in sorting using a multi-core processor.

However, the use of the frequency distribution data generated by the frequency distribution data generation device 100 is not limited to a specific use. For example, the frequency distribution data generation device 100 may generate frequency distribution data in order to present a frequency distribution table or a histogram to the user.

Moreover, the numbers included in the input data are not limited to integers. The numbers included in the input data can be various numbers below a predetermined digit number, such as a decimal number with a fixed digit number after the decimal point.

Moreover, in the case where the frequency distribution data generation device 100 generates frequency distribution data used for sorting a numerical sequence, the frequency distribution data generation device 100 itself may include a sorting function. Alternatively, the device that performs sorting may be configured as a separate device from the frequency distribution data generation device 100, and the frequency distribution data generation device 100 may transmit frequency distribution data to the device that performs the sorting.

Also, when the frequency distribution data generation device 100 generates frequency distribution data used for sorting a numerical sequence, the sorting is not limited to sorting using a multi-core processor. For example, a multi-node server may perform multi-node sorting using the frequency distribution data generated by the frequency distribution data generation device 100.

The communication unit 110 communicates with other devices. For example, the communication unit 110 may acquire a numerical sequence of a frequency distribution data generation target through communication with a device that stores the numerical sequence of the frequency distribution data generation target. In such a case, the numerical sequence acquired by the communication unit 110 corresponds to an example of input data.

The display unit 120 includes a display screen such as a liquid crystal panel or an LED (light emitting diode) panel, and displays various types of images. For example, the display unit 120 may display the frequency distribution data generated by the frequency distribution data generation device 100 in a table format.

The operation input unit 130 includes input devices such as a keyboard and a mouse, and receives user operations. For example, the operation input unit 130 may receive a user operation that instructs generation of frequency distribution data.

The storage unit 180 stores various types of data. For example, the storage unit 180 may store input data. The storage unit 180 is configured using a storage device included in the frequency distribution data generation device 100.

The control unit 190 controls each unit of the frequency distribution data generation device 100 and executes various processes. All or some of the functions of the control unit 190 may be executed by a CPU (central processing unit) included in the frequency distribution data generation device 100 reading out a program from the storage unit 180 and executing the program.

The interval number determination unit 191 estimates whether or not the number of intervals included in frequency distribution data at the time when all numbers included in input data are reflected in the frequency distribution data, is greater than a predetermined threshold value. That is to say, in the case where the frequency distribution data generation device 100 completes frequency distribution data that reflects all numbers included in input data with the current interval width setting, the interval number determination unit 191 predicts whether or not the number of intervals included in the frequency distribution data, is greater than a predetermined threshold. The interval number determination unit 191 corresponds to an example of the interval number determination means.

For example, the frequency distribution data generation device 100 generates frequency distribution data such that the numbers included in the input data are reflected in the frequency distribution data one by one. The interval number determination unit 191 then determines whether or not the number of intervals included in the frequency distribution data being generated by the frequency distribution data generation device 100, is greater than the threshold value. If it is determined that the number of intervals included in the frequency distribution data being generated by the frequency distribution data generation device 100 is greater than the threshold value, the interval number determination unit 191 estimates that, with the current interval width setting, the number of intervals included in the frequency distribution data reflecting all the numbers included in the input data is also greater than the threshold value.

The number of intervals included in frequency distribution data is also referred to as the size of frequency distribution data. The number of intervals included in frequency distribution data being large is also referred to as the size of frequency distribution data being large. The number of intervals included in frequency distribution data being small is also referred to as the size of frequency distribution data being small.

If the interval number determination unit 191 estimates that the number of intervals included in the frequency distribution data at the time when all the numbers included in the input data are reflected, is greater than the predetermined threshold, the interval width setting unit 192 changes the interval width to a wider interval width.

The interval width setting unit 192 corresponds to an example of the interval width setting means.

An interval width being wide is also referred to as an interval width being large. An interval width being narrow is also referred to as an interval width being small.

The interval width setting unit 192 repeatedly changes the interval width until the interval number determination unit 191 no longer estimates that the number of intervals included in the frequency distribution data at the time when all the numbers included in the input data are reflected, is greater than the predetermined threshold. Specifically, the interval width setting unit 192 re-sets the setting of the interval width to a wider interval width each time the interval number determination unit 191 estimates that the number of intervals included in the frequency distribution data at the time when all the numbers included in the input data are reflected, is greater than the predetermined threshold.

Here, it is expected that the wider the interval width, the fewer the number of intervals included in the obtained frequency distribution data, and that frequency distribution data generation and access to the obtained frequency distribution data can be performed in an even shorter period of time.

On the other hand, when the interval width is wide, the number of numbers assigned to cores varies depending on the distribution of numbers included in the input data.

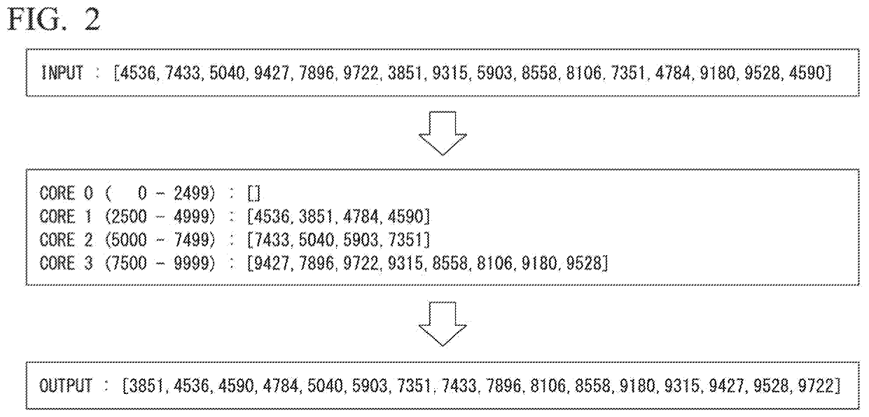

FIG. 2 is a diagram showing an example of allocating sort-target integers to cores. FIG. 2 shows an example in which the interval from 0 to 9999 is divided into four intervals with the same interval width, and the integers included in each interval are allocated to the cores.

In the example of FIG. 2, four integers are each assigned to core 1 and core 2, and eight integers are assigned to core 3. On the other hand, no integer is assigned to core 0.

Thus, in the case where the distribution of integers is biased, providing the same number of intervals with the same interval width as the number of cores will result in variation in the number of integers included in the intervals depending on the interval, which will degrade the sorting load balance.

Therefore, as described above, the interval width setting unit 192 re-sets the interval width so that the number of intervals included in the frequency distribution data (finally obtained frequency distribution data) that reflects all the integers included in the input data is equal to or less than the threshold value.

As a result, the interval width can be made as large as possible within the range in which the number of intervals included in the frequency distribution data generated by the frequency distribution data generation device 100, is equal to or less than the threshold value, while allowing room for adjusting the trade-off between the reduction in the generation time of the frequency distribution data and the time for accessing the obtained frequency distribution data, and equalization of integer allocation to each core. According to the frequency distribution data generation device 100, in this respect, when generating data indicating a frequency distribution of integers included in a numerical sequence, it is possible in a relatively short time to generate data indicating the frequency distribution of interval widths corresponding to the numerical sequence.

The frequency distribution data generation unit 193 executes generation of frequency distribution data. In particular, when the interval width setting unit 192 changes the interval width, the frequency distribution data generation unit 193 generates frequency distribution data, using the interval width of after the change.

The frequency distribution data with an interval width of before the change is also referred to as frequency distribution data of before interval width change. The frequency distribution data with an interval width of after the change is also referred to as frequency distribution data of after interval width change.

For example, as described above regarding the frequency distribution data generation device 100, the interval number determination unit 191 determines whether or not the number of intervals included in the frequency distribution data being generated by the frequency distribution data generation device 193, is greater than the threshold value. Then, if the interval number determination unit 191 determines the number of intervals as being greater than the threshold value, the frequency distribution data generation unit 193 stops the generation of the frequency distribution data of before interval width change, and generates frequency distribution data of after interval width change.

The frequency distribution data generation unit 193 corresponds to an example of the frequency distribution data generation means.

The frequency distribution data generation unit 193 may generate frequency distribution data in the form of a hash table. The hash table referred to here is a table that includes rows of combinations of keys and values.

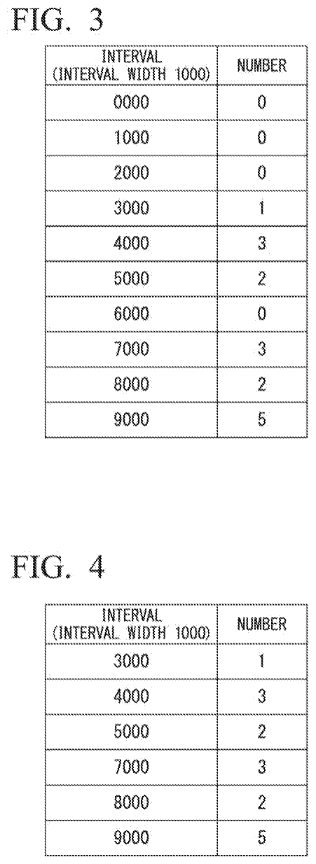

FIG. 3 is a diagram showing an example of frequency distribution data in the form of a hash table.

In the example in FIG. 3, the interval from 0 to 9999 is divided into intervals with an interval width of 1000, such as 0 to 999, 1000 to 1999, and so on, and the number of integers included in each interval is indicated. Each interval is indicated by a four-digit representation of the minimum value of the interval, such as “0000”, “1000”, and so on.

A four-digit integer indicating the minimum value of each interval corresponds to an example of a key in the hash table. The number of integers included in each interval corresponds to an example of a value in the hash table.

The number of rows in the hash table corresponds to an example of the number of intervals included in the frequency distribution data.

The frequency distribution data generation unit 193 may generate frequency distribution data in the form of a hash table that includes no intervals in which the number of numbers included in the input data is zero.

FIG. 4 is a diagram showing an example of frequency distribution data in the form of a hash table that includes no intervals in which the number of numbers included in input data is zero. FIG. 4 shows frequency distribution data obtained by removing rows in which the number of integers included in the input data is zero, from the frequency distribution data in the example of FIG. 3.

The frequency distribution data generation unit 193 generates the frequency distribution data in the form of a hash table that includes no intervals in which the number of numbers included in the input data is zero, thereby making the number of intervals included in the frequency distribution data (number of rows in the hash table) relatively small. In this respect, according to the frequency distribution data generation unit 193, the time required to generate frequency distribution data and the time required to access the generated frequency distribution data is relatively short. The frequency distribution data generation unit 193 generates the frequency distribution data in the form of a hash table that includes no intervals in which the number of numbers included in the input data is zero, whereby a relatively small memory capacity is required to store the frequency distribution data.

Moreover, in a hash table that includes no intervals in which the number of numbers included in the input data is zero, the number of intervals that are not indicated by a key (an interval in which the key indicating that an interval is not included in the hash table) can be read as zero. In this respect, the hash table can provide the same information as frequency distribution data that includes intervals in which the number of numbers included in the input data is zero.

In the following, a case will be described as an example in which the frequency distribution data generation unit 193 generates frequency distribution data in a hash table format that includes no intervals in which the number of numbers included in the input data is zero. However, the format of the frequency distribution data generated by the frequency distribution data generation device 193 is not limited to a specific format.

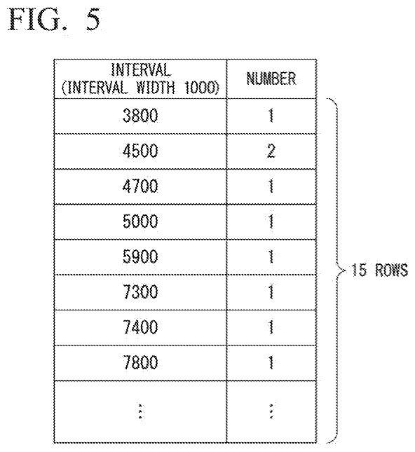

FIG. 5 is a diagram showing an example of frequency distribution data having a relatively narrow interval width. While FIG. 4 shows an example of frequency distribution data with an interval width of 1000, FIG. 5 shows frequency distribution data with an interval width of 100. Both the frequency distribution data in FIG. 4 and the frequency distribution data in FIG. 5 indicate the distribution of integers included in the input data in the example of FIG. 2.

Two integers included in the interval from 4500 to 4599 and one integer included in the interval from 4700 to 4799, that is, a total of three integers in the example of FIG. 5 are included the interval from 4000 to 4999 in the example of FIG. 4. Moreover, one integer included in the interval from 5000 to 5099 and one integer included in the interval from 5900 to 5999, that is, a total of two integers in the example of FIG. 5 are included the interval from 5000 to 5999 in the example of FIG. 4.

As in the example in FIG. 5, in the case where the interval width is set relatively narrow, the number of integers included in each interval becomes more uniform, which makes it easier to equalize the number of integers assigned to each core, to the greatest extent possible when assigning integers to cores.

On the other hand, in the case where the interval width is set relatively narrow, the number of intervals included in the frequency distribution data becomes relatively large, and it may take time to generate frequency distribution data and access the generated frequency distribution data. In the example of FIG. 4, the number of intervals included in the frequency distribution data is six, whereas in the example of FIG. 5, the number of intervals included in the frequency distribution data is fifteen.

Here, the appropriate interval width depends on the target numerical sequence of frequency distribution data generation.

In the case where the numbers included in the numerical sequence are distributed uniformly to some extent, it is expected that the number of numbers included in each interval will be uniform to some extent even if the interval width is set relatively large. On the other hand, if the distribution of numbers included in the numerical sequence is biased, it may be necessary to set the interval width small in order to make the number of numbers included in each interval somewhat uniform.

The appropriate interval width depends on the target numerical sequence of frequency distribution data generation, and it is thus difficult to preliminarily set the interval width appropriately. Therefore, the interval width setting unit 192 sets the interval width relatively small, and increases the interval width until the number of intervals included in the frequency distribution data becomes equal to or less than a predetermined threshold value.

In this way, by changing the interval width by the interval width setting unit 192, it is possible for the frequency distribution data generation unit 193 to generate frequency distribution data in which the number of intervals is equal to or less than a predetermined threshold value, with an interval width according to the target numerical sequence of frequency distribution data generation.

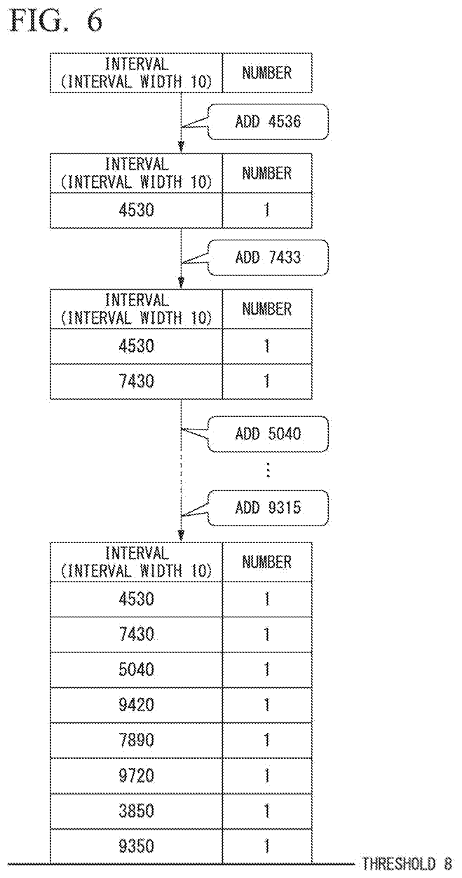

FIG. 6 is a diagram showing a first example of changing frequency distribution data in the process of generating frequency distribution data by means of the frequency distribution data generation device 100. FIG. 6 shows an example of a case in which the frequency distribution data generation device 100 generates frequency distribution data of integers included in the input data shown in FIG. 2. Moreover, in the example of FIG. 6, the threshold value for the number of intervals included in the frequency distribution data is set to 8.

In the example of FIG. 6, the interval width setting unit 192 initially sets the interval width to 10, and the frequency distribution data generation unit 193 starts generating frequency distribution data using the interval width initially set by the interval width setting unit 192. The interval width setting unit 192 sets frequency distribution data in a table format with zero rows, as the initial value of the frequency distribution data.

Next, the interval width setting unit 192 sequentially makes reference to the integers included in the numerical sequence for which frequency distribution data is to be generated, starting from the beginning of the numerical sequence, and reflects them in the frequency distribution data.

Specifically, the interval width setting unit 192 makes reference to the first integer “4536” in the input data and calculates “4530” as a key with the ones place replaced with “0” according to the interval width 10. Since there is no row with the key “4530” in the frequency distribution data at that point, the interval width setting unit 192 adds a row with the key “4530” and the value “1” to the frequency distribution data. Replacing the ones place of an integer with “0” is an example of masking an integer.

Next, the interval width setting unit 192 makes reference to the second integer “7433” in the input data and calculates the key as “7430”. Since there is no row with the key “7430” in the frequency distribution data at that point, the interval width setting unit 192 adds a row with the key “7430” and the value “1” to the frequency distribution data.

In this way, the interval width setting unit 192 sequentially makes reference to the integers in the input data from the beginning and changes the frequency distribution data. In the example of FIG. 6, at the point in time when the interval width setting unit 192 has changed the frequency distribution data by making reference to the eighth integer “9315” from the beginning in the input data, the number of rows of the frequency distribution data reaches the threshold value 8.

Note that FIG. 6 shows an example in which the interval width setting unit 192 does not sort the frequency distribution data during the generation of the frequency distribution data. Alternatively, when adding a row to the frequency distribution data, the interval width setting unit 192 may sort the frequency distribution data during the generation of the frequency distribution data, such as inserting the row so that the key values are in ascending order.

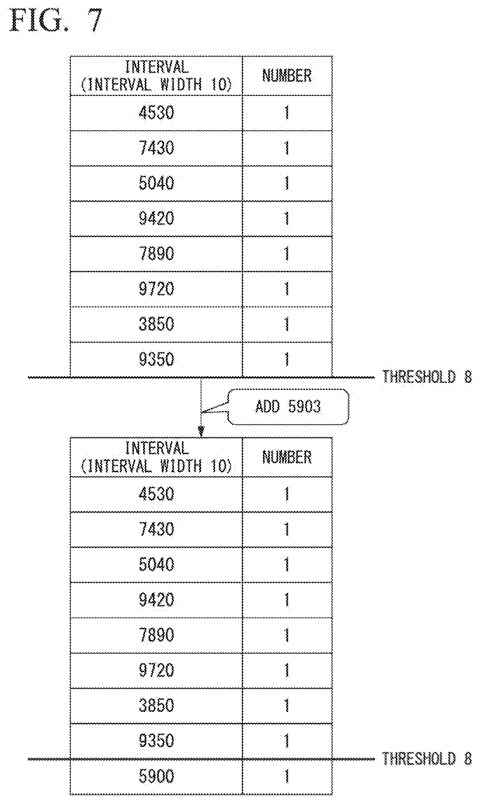

FIG. 7 is a diagram showing a second example of changing frequency distribution data in the process of generating frequency distribution data by means of the frequency distribution data generation device 100. FIG. 7 shows an example in which the interval width setting unit 192 further changes the frequency distribution data by making reference to the ninth integer “5903” of the input data from the example of FIG. 6.

The interval width setting unit 192 makes reference to the ninth integer “5903” in the input data and calculates the key as “5900”. Since there is no row with the key “5900” in the frequency distribution data at that point, the interval width setting unit 192 adds a row with the key “5900” and the value “1” to the frequency distribution data.

As a result, the number of rows of the frequency distribution data is nine, and the interval number determination unit 191 determines that the number of intervals included in the frequency distribution data with an interval width 10, is greater than the threshold value 8.

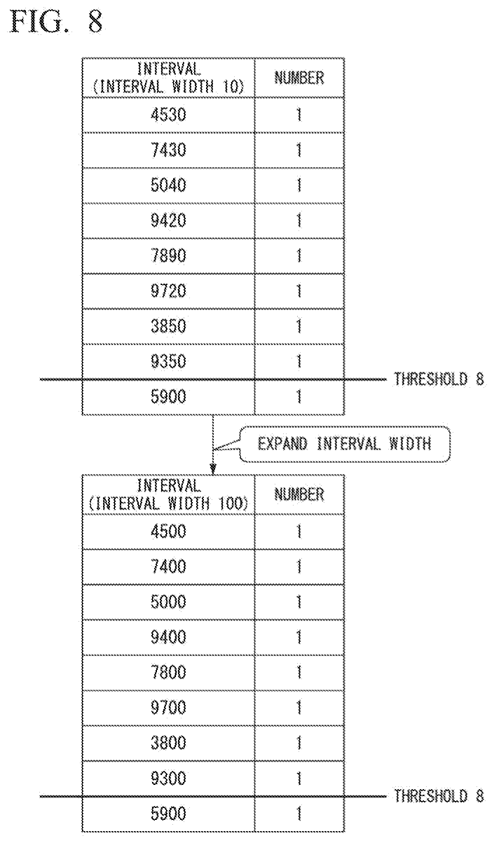

FIG. 8 is a diagram showing a third example of changing frequency distribution data in the process of generating frequency distribution data by means of the frequency distribution data generation device 100. FIG. 8 shows an example in which the interval width setting unit 192 changes the interval width from the example shown in FIG. 7.

The interval width setting unit 192 changes the interval width to 100 in response to the interval number determination unit 191 having determined the number of intervals included in the frequency distribution data with an interval width of 10, being greater than the threshold value 8.

Accompanying the change to the interval width, the frequency distribution data generation unit 193 replaces the tens place of each key included in the frequency distribution data with “0”.

Replacing the tens place of an integer with “0” is an example of masking an integer. Since the key before changing the interval width is generated by masking the integer included in the input data, replacing the tens place of the key before changing the interval width with “0” corresponds to an example of (multiple) masking.

In this way, the interval width setting unit 192 changes the interval width to a wider interval width, whereby the frequency distribution data generation unit 193 can relatively easily change the frequency distribution data of before the interval width change to the frequency distribution data of after the interval width change.

In particular, the interval width setting unit 192 may change the interval width so that any interval of before interval width change is included in one interval of after interval width change. The frequency distribution data generation unit 193 may total the number of numbers included in an interval of before interval width change, regarding all intervals before interval width change included in the same interval of after interval width change.

By setting the calculated number to the number of numbers included in the interval of after the interval width change, the frequency distribution data generation unit 193 can reflect the number of numbers in each interval indicated in the frequency distribution data of before the interval width change to the number of numbers included in the interval of after the interval width change. Thus, the frequency distribution data generation unit 193 does not need to access the input data again for the numbers included in the input data that have already been reflected in the frequency distribution data of before the interval width change.

For example, in the example in FIG. 8, in frequency distribution data with an interval width of 10, the integer included in the interval from 4530 to 4539, which is indicated by the key “4530”, is, in the frequency distribution data with an interval width of 100, included in the interval from 4500 to 4599, which is indicated by the key “4500”. As a result, it is sufficient that the frequency distribution data generation device 100 reflects the value “1” in the row with the key “4530” in the frequency distribution data with an interval width of 10 to the value in the row with the key “4500” in the frequency distribution data with an interval width of 100, and the integer “4536” included in the input data need not be referenced again.

Moreover, where n is an integer such that n≥1, m is an integer such that m≥0, and the base number used by the frequency distribution data generation device 100 for representing numbers is an n-base number, the interval width setting unit 192 sets the interval width of n^{m}, whereby the frequency distribution data generation device 193 can calculate a key by masking the numbers included in the input data. In this respect, the frequency distribution data generation unit 193 can calculate the key relatively easily.

In the example of FIG. 8, the numbers are represented in decimal notation, and the interval width setting unit 192 changes the interval width from 10¹ to 10². Then, the frequency distribution data generation unit 193 calculates keys by masking the numbers included in the input data, for both the frequency distribution data of before the interval width change and the frequency distribution data of after the interval width change.

For example, in the frequency distribution data of before the interval width change, the frequency distribution data generation unit 193 sets intervals such as the interval from 4530 to 4539, so that the upper three digits of integers that can be included in the same interval are common. Then, as shown in FIG. 6, the frequency distribution data generation unit 193 calculates the key “4530” by replacing the ones place of the integer “4536” included in the input data with “0”.

As described above, replacing the ones place of an integer with “0” is an example of masking an integer.

Moreover, in the frequency distribution data of after the interval width change, the frequency distribution data generation unit 193 sets intervals such as the interval from 4500 to 4599, so that the upper two digits of integers that can be included in the same interval are common. Then, the frequency distribution data generation unit 193 calculates the key “4500” by replacing the tens place of the key “4530” before the interval width change with “0”. As described above, replacing the tens place of the key before changing the interval width with “0” is an example of (multiple) masking an integer.

In the example of FIG. 8, there is no duplication of keys in the frequency distribution data after the keys are rewritten, and the number of rows of the frequency distribution data remains nine. As a result, the interval number determination unit 191 determines that the number of intervals included in the frequency distribution data with an interval width 100 is greater than the threshold value 8.

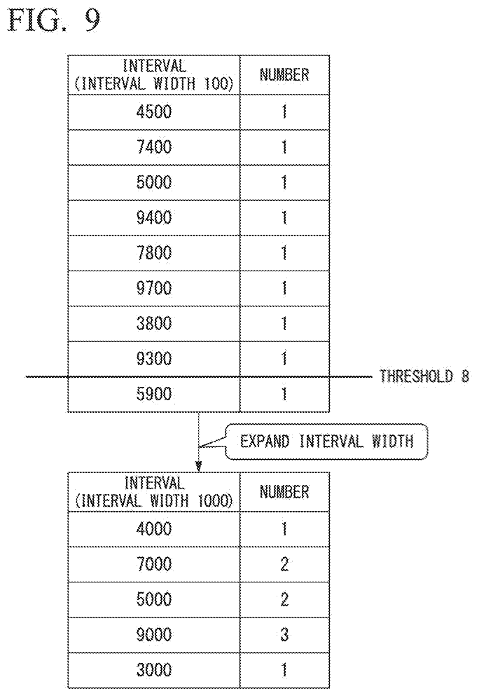

FIG. 9 is a diagram showing a fourth example of changing frequency distribution data in the process of generating frequency distribution data by means of the frequency distribution data generation device 100. FIG. 9 shows an example in which the interval width setting unit 192 changes the interval width from the example shown in FIG. 8.

The interval width setting unit 192 changes the interval width to 1000 in response to the interval number determination unit 191 having determined the number of intervals included in the frequency distribution data with an interval width of 100, being greater than the threshold value 8.

As the change is made to the interval width, the frequency distribution data generation unit 193 replaces the hundreds place of each key with “0”. Replacing the hundreds place of an integer with “0” is an example of masking an integer. Also, replacing the hundreds place of the key before changing the interval width with “0” is an example of (multiple) masking an integer.

Then, the frequency distribution data generation unit 193 combines the rows in which keys overlap after changing the interval width, into one row. For example, keys “7400” and “7800” in the frequency distribution data with an interval width of 100 both become keys “7000” in the frequency distribution data with an interval width of 1000. Accordingly, the frequency distribution data generation unit 193 adds the value “1” of the row with the key “7400” and the value “1” of the row with the key “7800” in the frequency distribution data with an interval width of 100, to yield the value “2” of the row with the key “7000” in the frequency distribution data with a width of 1000.

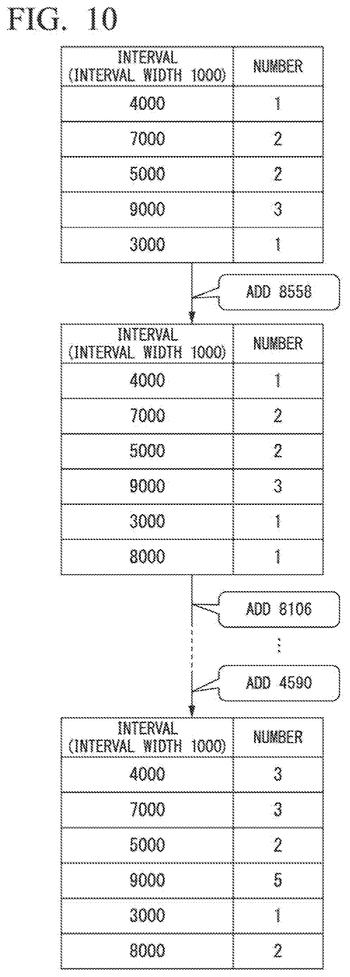

FIG. 10 is a diagram showing a fifth example of changing frequency distribution data in the process of generating frequency distribution data by means of the frequency distribution data generation device 100. FIG. 10 shows an example of a case in which the frequency distribution data generation unit 193 changes frequency distribution data from the example of FIG. 9.

At the point in time of the example of FIG. 9, when the frequency distribution data generation unit 193 makes reference to the integers included in the input data up to the ninth integer “5903” from the beginning, the number of rows of the frequency distribution data with an interval width 1000 is 5, which is less than the threshold value 8. Accordingly, the frequency distribution data generation unit 193 makes further reference to the integers in the input data and changes the frequency distribution data.

Specifically, in the example of FIG. 10, the frequency distribution data generation unit 193 makes reference to the tenth integer “8558” from the beginning in the input data and calculates the key as “8000”. Then, since there is no row with the key “8000” in the frequency distribution data, the frequency distribution data generation unit 193 adds a row with the key “8000” and the value “1” to the frequency distribution data.

Furthermore, the frequency distribution data generation unit 193 sequentially make reference to the tenth integer “8106” from the beginning in the input data to the last integer “4590”, and changes the frequency distribution data.

At the point in time when the frequency distribution data generation unit 193 reflects the last integer “4590” of the input data in the frequency distribution data, the number of rows of the frequency distribution data is six, which is less than the threshold value 8. Accordingly, the frequency distribution data generation device 100 employs this frequency distribution data as the frequency distribution data of the numbers included in the input data.

The numerical representation format used by the frequency distribution data generation device 100 is not limited to a specific format.

For example, the frequency distribution data generation device 100 may generate frequency distribution data, using bit sequence data representing numbers in binary. Furthermore, when the frequency distribution data generation device 100 uses bit sequences, the numerical representation format using a bit sequence is not limited to a specific format. For example, when the frequency distribution data generation device 100 uses data representing one number using a 32-bit bit sequence, the 32-bit bit sequence may represent an integer from −2³¹ to 2³¹ −1, using a complement representation of 2. Alternatively, the bit sequence may be defined to represent an integer greater than or equal to 0, and the 32-bit bit sequence may represent an integer from 0 to 2³²−1, or may represent a decimal number, such as a 32-bit bit sequence representing a fixed decimal number in binary.

When the frequency distribution data generation unit 193 uses data in which numbers are represented using bit sequences to generate frequency distribution data, the key may be calculated by masking the bit sequences.

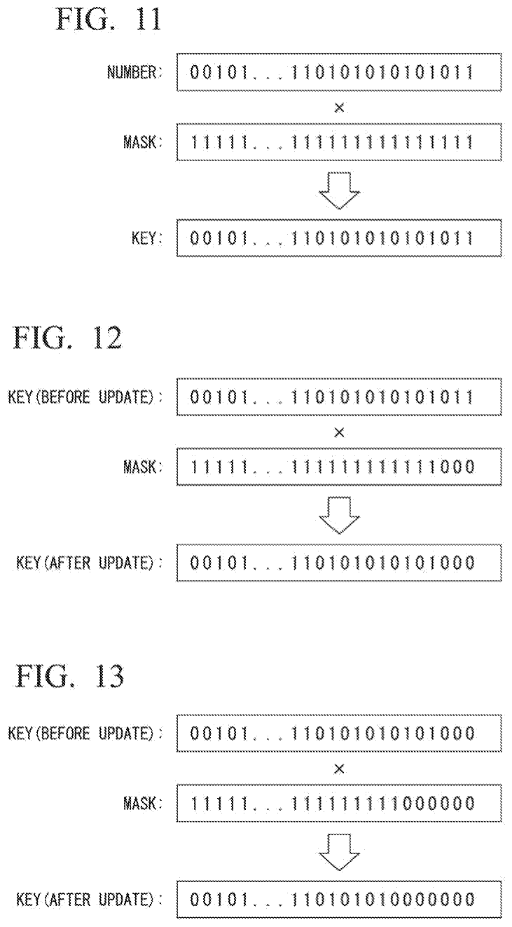

FIG. 11 is a diagram showing a first example of a key calculated by means of masking on a bit sequence performed by a frequency distribution data generation unit 193.

FIG. 11 shows an example in which the frequency distribution data generation unit 193 calculates a key by masking a bit sequence indicating a number included in input data when the interval width is set to 1. In such a case, the frequency distribution data generation unit 193 sets the mask to a bit sequence with the same bit length as the bit sequence indicating the number included in the input data and all bits being “1”. Alternatively, the interval width setting unit 192 may set the mask.

Then, the frequency distribution data generation unit 193 takes the product of the bit sequence indicating the number included in the input data and the mask for each bit, and calculates the same bit sequence as a bit sequence indicating the number included in the input data as a key.

As in the example of FIG. 11, if the key is the same as the original number, the frequency distribution data generation unit 193 may omit masking for the number and use the number as it is as the key.

FIG. 12 is a diagram showing a second example of a key calculated by means of masking on a bit sequence performed by a frequency distribution data generation unit 193.

FIG. 12 shows that when the interval width setting unit 192 changes the interval width from 1 to 2³=8, the frequency distribution data generation unit 193 uses masking for the key before the interval width change to calculate the key after the interval width change. In such a case, the frequency distribution data generation unit 193 sets the mask for a bit sequence such that its bit length is the same as the key before the interval width change, its last three bits are all “0”, and all other bits are “1”. Then, the frequency distribution data generation unit 193 calculates the key after the interval width change by calculating, for each bit, the product of the key before the interval width change and the mask.

FIG. 13 is a diagram showing a third example of a key calculated by means of masking on a bit sequence performed by a frequency distribution data generation unit 193.

FIG. 13 shows that when the interval width setting unit 192 changes the interval width from 2 to 2³=8 to 2⁶=64, the frequency distribution data generation unit 193 uses masking for the key before the interval width change to calculate the key after the interval width change. In such a case, the frequency distribution data generation unit 193 sets the mask for a bit sequence such that its bit length is the same as the key before the interval width change, its last six bits are all “0”, and all other bits are “1”. Then, the frequency distribution data generation unit 193 calculates the key after the interval width change by calculating, for each bit, the product of the key before the interval width change and the mask.

In this way, the frequency distribution data generation unit 193 performs masking on the bit sequence included in the input data or the key before interval width change, to mask a number of bits from the end of the bit sequence according to the interval width, thereby calculating the key after interval width change. As in the examples from FIG. 6 to FIG. 10, the frequency distribution data generation device 100 repeats to change the interval width and calculate the key after the interval width change, until the number of rows in the hash table is equal to or less than the predetermined threshold value.

When the frequency distribution data generation unit 193 calculates a key by performing masking on a bit sequence, the interval width setting unit 192 can make various changes in the interval width such as expanding the interval width to an interval width represented as 2^{m}, with m being an integer where m≥0.

For example, the interval width setting unit 192 may initially set the interval width to 2⁰, and change the interval width in such a way that m of 2^{m} is increased by 1, such as sequentially changing the interval width to 2¹, 2², and so forth each time the interval number determination unit 191 determines the number of intervals as being greater than a predetermined threshold value.

In such a case, the frequency distribution data generation unit 193 or the interval width setting unit 192 initially sets the values of all bits of the mask to “1”, and, each time the interval width is changed, changes the bit value from “1” to “0”, one bit at a time starting from the last bit.

The fewer the number of bits that the frequency distribution data generation unit 193 changes its value to “0” at a time (that is, the relatively smaller the post-change interval width set by the interval width setting unit 192), the more detailed the interval width can be searched for, and the less likely an appropriate interval width will be missed in search.

On the other hand, the more the number of bits that the frequency distribution data generation unit 193 changes its value to “0” at a time (that is, the relatively larger the post-change interval width set by the interval width setting unit 192), the lower the expectation of the frequency of changing interval width will be.

Moreover, in the case where information regarding the distribution of numbers included in input data has been obtained, the interval width setting unit 192 or the user may set the initial value of the interval width according to the distribution of numbers included in the input data.

For example, in the case where the distribution of numbers included in the input data is relatively uniform, the numbers are expected to be included in each interval relatively uniformly even if the interval width is broadened to some extent. Also, in the case where the distribution of numbers included in the input data is relatively uniform, it is conceivable that there will be more intervals containing one or more numbers than in the case where the distribution is biased, and that the interval width of the frequency distribution data to be eventually obtained will be relatively wide.

Therefore, if information is obtained that the distribution of numbers included in the input data is relatively uniform, the interval width setting unit 192 or the user may set the initial value of the interval width to a relatively wide interval. For example, the frequency distribution data generation unit 193 or the interval width setting unit 192 may set the initial value of the mask such that the values from the last bit to a predetermined bit of the mask are “0” and the values of the rest of the bits are “1”.

Moreover, the interval width setting unit 192 may change the setting regarding the magnitude of interval width change, according to the number of times the interval width is changed.

For example, in the case where m is an integer where m≥0 and the interval width setting unit 192 sets the interval width to an interval width represented by 2^{m}, the interval width increases exponentially as the value of m increases. Therefore, for example, the interval width setting unit 192 increases m by 2, such as 2⁰, 2², 2⁴, . . . 2¹⁰, until m reaches 10, and m may be increased by 1 after m has reached 10, such as 2¹¹, 2¹², 2¹³, and so on.

The frequency distribution data generation unit 193 may extract only the bits the mask value of which “s” “1” from among the respective bits of the key obtained by masking. That is to say, the frequency distribution data generation unit 193 may discard the bits the mask value of which “s” “0”, from among the respective bits of the key obtained by masking. As a result, it is expected that the bit length of the key will be relatively short, and that the memory capacity required to store the key will be relatively small.

When the frequency distribution data generation unit 193 uses data in which numbers are represented using bit sequences to generate frequency distribution data, the key may be calculated by means of shift operation.

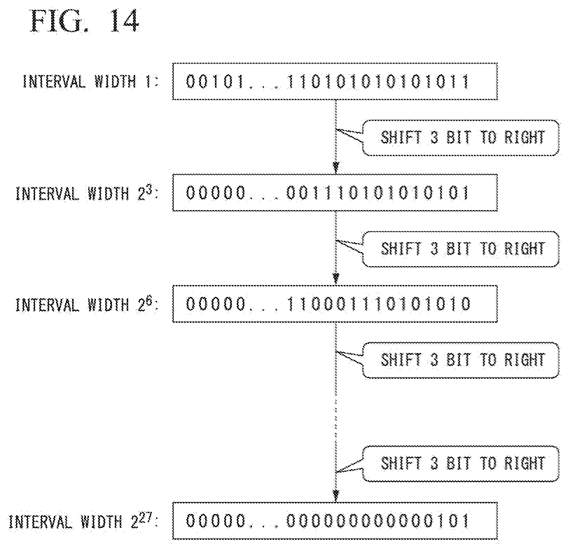

FIG. 14 is a diagram showing an example of keys calculated by means of shift operation performed by the frequency distribution data generation unit 193. FIG. 14 shows an example in which the frequency distribution data generation unit 193 increases the interval width by 3 digits in binary representation, such as 1(=2⁰), 2³, 2⁶, and so on.

In the example of FIG. 14, the interval width setting unit 192 initially sets the value of the interval width to 1. Accordingly, the frequency distribution data generation unit 193 uses the bit sequence indicating the number included in the input data as a key at the time when the interval width is 1.

Next, the interval width setting unit 192 changes the interval width from 1 to 2³=8. Then, the frequency distribution data generation unit 193 calculates the key at the time when the interval width is 2³, by shifting the key at the time when the interval width is 1 to the right by 3 bits.

Furthermore, the interval width setting unit 192 changes the interval width from 2³=8 to 2⁶=64. Then, the frequency distribution data generation unit 193 calculates the key at the time when the interval width is 2⁶, by shifting the key at the time when the interval width is 2³ to the right by 3 bits.

In this way, the frequency distribution data generation unit 193 performs, on the bit sequence included in the input data or the key before interval width change, right shifting by the number of bits according to the change in the interval width, thereby calculating the key after interval width change. As in the examples from FIG. 6 to FIG. 10, the interval width setting unit 192 and the frequency distribution data generation unit 193 repeat to change the interval width and calculate the key after the interval width change, until the number of rows in the hash table is equal to or less than the predetermined threshold value. In the example of FIG. 14, the frequency distribution data generation unit 193 repeatedly right-shifts three bits until the interval width is 2²⁷, to repeatedly calculate the key after interval width change.

The frequency distribution data generation unit 193 may discard bits into which “0” has been inserted through the shift operation, among the bits of the key obtained by the shift operation. As a result, it is expected that the bit length of the key will be relatively short, and that the memory capacity required to store the key will be relatively small.

Also, depending on the method of shift operation, the frequency distribution data generation unit 193 may perform masking on the result of the shift operation. For example, in the case where “1” is inserted through the right-shifting operation for a positive number, the frequency distribution data generation unit 193 may perform masking, replacing bit sequences in which “1” is inserted through the shift operation with “0”, among the bits of the key obtained by the shift operation.

When the frequency distribution data generation unit 193 calculates a key by performing the shift operation on a bit sequence, the interval width setting unit 192 can make various changes in the interval width such as expanding the interval width to an interval width represented as 2^{m}, with m being an integer where m≥0.

For example, the interval width setting unit 192 may initially set the interval width to 2⁰, and change the interval width in such a way that m of 2 ^{m} is increased by 1, such as sequentially changing the interval width to 2¹, 2², and so forth each time the interval number determination unit 191 determines the number of intervals as being greater than a predetermined threshold value.

In such a case, each time the interval width is changed, the frequency distribution data generation unit 193, one bit at a time, right-shifts the number included in the input data or the key before the interval width change obtained by the shift operation performed on the number included in the input data.

The fewer the number of bits that the frequency distribution data generation unit 193 shifts the key at a time (that is, the relatively smaller the post-change interval width set by the interval width setting unit 192), the more detailed the interval width can be searched for, and the less likely an appropriate interval width will be missed in search.

On the other hand, the more the number of bits that the frequency distribution data generation unit 193 shifts the key at a time (that is, the relatively larger the post-change interval width set by the interval width setting unit 192), the lower the expectation of the frequency of changing interval width will be.

As described above, in the case where information regarding the distribution of numbers included in input data has been obtained, the interval width setting unit 192 or the user may set the initial value of the interval width according to the distribution of numbers included in the input data.

For example, if information is obtained that the distribution of numbers included in the input data is relatively uniform, the interval width setting unit 192 or the user may set the initial value of the interval width to a relatively wide interval. When generating frequency distribution data with an interval width of the initial value, the frequency distribution data generation unit 193 calculates a key by shifting the number read from the input data by the number of bits according to the initial value of the interval width.

As described above, the interval width setting unit 192 may change the setting regarding the magnitude of the interval width change, according to the number of times the interval width is changed.

The frequency distribution data generation unit 193 may extract only bits other than the bits the values of which were inserted through the shift operation, among the bits of the key obtained by the shift operation. That is to say, the frequency distribution data generation unit 193 may discard bits into which a value has been inserted through the shift operation, among the bits of the key obtained by the shift operation. As a result, it is expected that the bit length of the key will be relatively short, and that the memory capacity required to store the key will be relatively small.

FIG. 15 is a diagram showing an example of a processing procedure of frequency distribution data generation performed by the frequency distribution data generation device 100.

In the example of FIG. 15, the interval width setting unit 192 initially sets the interval width (Step S101). Note that when the frequency distribution data generation unit 193 calculates a key using a mask, each time the interval width setting unit 192 sets or changes the interval width, the frequency distribution data generation unit 193 or the interval width setting unit 192 sets a mask according to the interval width.

Next, the frequency distribution data generation unit 193 reads out one number included in the input data (Step S102). For example, each time the process transitions to Step S102, the frequency distribution data generation unit 193 reads out the numbers one by one, starting from the beginning of the numerical sequence included in the input data.

Then, the frequency distribution data generation unit 193 calculates the key of the number that has been read out (Step S103). As described above, as the method of calculating the key, the frequency distribution data generation unit 193 can use various methods, such as using a mask or using a shift operation.

Next, the frequency distribution data generation unit 193 reflects the calculated key in the frequency distribution data (Step S104).

Specifically, the frequency distribution data generation unit 193 determines whether or not the key calculated in Step S103 is included in the frequency distribution data being generated. If the key calculated in Step S103 is determined as being included in the frequency distribution data being generated, the frequency distribution data generation unit 193 increases the value of the row including the key by 1. That is to say, the frequency distribution data generation unit 193 increases the number of numbers included in the interval indicated by the calculated key by 1.

On the other hand, if the key calculated in Step S103 is determined as not being included in the frequency distribution data being generated, the frequency distribution data generation unit 193 adds a row based on the combination of the calculated key and the value “1”, to the frequency distribution data. That is to say, the frequency distribution data generation unit 193 adds a row indicating a new interval to the frequency distribution data, and sets the number of numbers included in that interval to 1.

Next, the interval number determination unit 191 determines whether or not the number of intervals included in the frequency distribution data being generated, is greater than a predetermined threshold value (Step S105).

If the interval number determination unit 191 determines the number of intervals as being greater than the threshold value (Step S105: YES), the interval width setting unit 192 changes the interval width setting to a wider interval width (Step S111).

Then, the frequency distribution data generation unit 193 changes the frequency distribution data being generated from the frequency distribution data of before the interval width change, to the frequency distribution data of after the interval width change (Step S112). After Step S112, the process returns to Step S105.

On the other hand, if the interval number determination unit 191 determines in Step S105 that the number of intervals included in the frequency distribution data being generated is less than or equal to the predetermined threshold value (Step S105: NO), the frequency distribution data generation unit 193 determines whether or not all the numbers included in the input data have been reflected in the frequency distribution data (Step S121).

If the frequency distribution data generation unit 193 determines that there are numbers included in the input data that are not reflected in the frequency distribution data (Step S121: NO), the process returns to Step S102.

On the other hand, if the frequency distribution data generation unit 193 determines that all the numbers included in the input data have been reflected in the frequency distribution data, the frequency distribution data generation device 100 ends the process of FIG. 15.

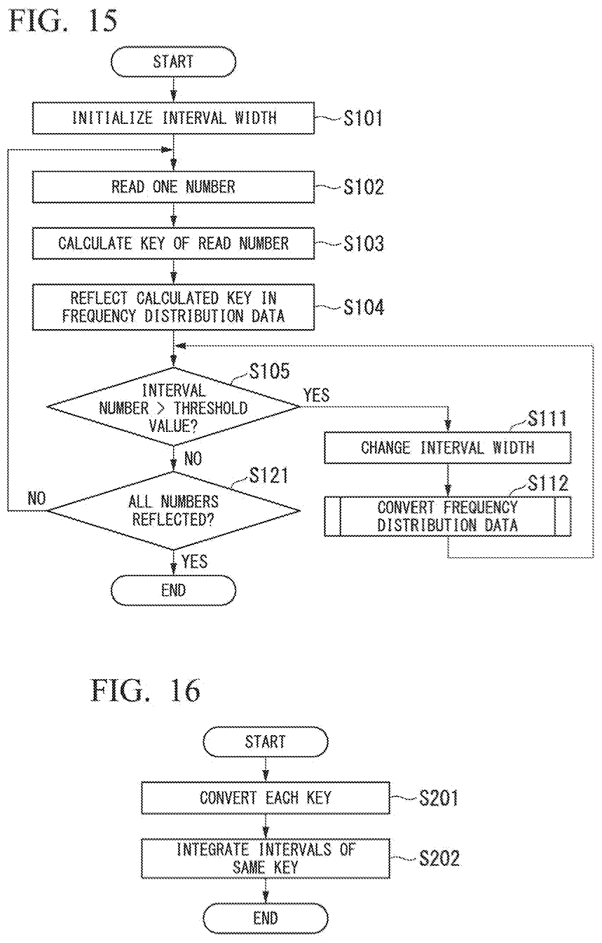

FIG. 16 is a diagram showing an example of a processing procedure in which the frequency distribution data generation unit 193 changes frequency distribution data of before interval width change to frequency distribution data of after interval width change. In Step S112 of FIG. 15, the frequency distribution data generation unit 193 performs the process shown in FIG. 16.

In the process of FIG. 16, the frequency distribution data generation unit 193 changes each key included in the frequency distribution data, in accordance with the change in interval width made in Step S111 of FIG. 15 (Step S201). As described above, as the method of changing the key, the frequency distribution data generation unit 193 can use various methods, such as using a mask or using a shift operation.

Next, the frequency distribution data generation unit 193 integrates intervals having the same key, among the intervals included in the frequency distribution data (Step S202). Specifically, the frequency distribution data generation unit 193 detects rows that include the same key among the rows of the frequency distribution data.

Then, the frequency distribution data generation unit 193 totals the values indicated in each row containing the same key, and rewrites the value indicated in any one of the rows containing the same key, to the obtained total value. That is to say, the frequency distribution data generation unit 193 totals the number of numbers included in the interval of before the interval width change that is included in the same interval in the interval of after the interval width change.

Then, the frequency distribution data generation unit 193 deletes the rows including the same key, other than the rows in which the value has been rewritten.

After Step S202, the frequency distribution data generation unit 193 ends the process of FIG. 16.

As described above, the interval number determination unit 191 estimates whether or not the number of intervals included in frequency distribution data at the time when all numbers included in the target numerical sequence for frequency distribution data generation are reflected in the frequency distribution data, is greater than the predetermined threshold value. The interval width setting unit 192 changes the interval width setting to a wider interval width if the number of the intervals is estimated to be greater than the threshold value. The frequency distribution data generation unit 193 generates frequency distribution data, using the interval width of after the change.

As a result, the frequency distribution data generation device 100 can generate frequency distribution data upon determining interval widths in accordance with the trade-offs such as: the higher the number of intervals included in the frequency distribution data, the longer it will take to generate the frequency distribution data; and the lower the number of intervals included in the frequency distribution data, the more likely variation will occur in the number of numbers included in each interval. According to the frequency distribution data generation device 100, in this respect, when generating data indicating the frequency distribution of numbers included in a numerical sequence, it is possible in a relatively short time to generate data indicating the frequency distribution of interval widths corresponding to the numerical sequence.

Moreover, the interval number determination unit 191 determines whether or not the number of intervals included in the frequency distribution data being generated by the frequency distribution data generation device 193 is greater than the threshold value, whereby the interval number determination unit 191 estimates whether or not the number of intervals included in the frequency distribution data at the time when all numbers included in the target numerical sequence for frequency distribution data generation are reflected in the frequency distribution data, is greater than the threshold value. If the number of the intervals is determined as being greater than the threshold value, the frequency distribution data generation unit 193 stops generating frequency distribution data with an interval width of before the change and generates frequency distribution data with an interval width of after the change.

As described above, the interval number determination unit 191 determines whether or not the number of intervals included in the frequency distribution data being generated by the frequency distribution data generation device 193 is greater than the threshold value, whereby the interval number determination unit 191 can highly accurately estimate whether or not the number of intervals included in frequency distribution data at the time when all numbers included in the target numerical sequence for frequency distribution data generation are reflected in the frequency distribution data, is greater than the threshold value. Also, if the number of the intervals is determined as being greater than the threshold value, the frequency distribution data generation unit 193 stops generating frequency distribution data with an interval width of before the change and generates frequency distribution data with an interval width of after the change, thereby making the amount of time required for generating frequency distribution data relatively short.

Moreover, the interval width setting unit 192 changes the interval width so that any interval of before interval width change is included in one interval of after interval width change. The frequency distribution data generation unit 193 totals the number of numbers included in an interval of before interval width change, regarding all intervals before interval width change included in the same interval of after interval width change.

As a result, among the numbers included in the target numerical sequence for frequency distribution generation, the frequency distribution data generation unit 193 can reflect the numbers that have already been reflected in the frequency distribution data of before the interval width change, in frequency distribution data of after the interval width change, without the need for referring back to the target numerical sequence for frequency distribution generation. According to the frequency distribution data generation device 100, in this respect, it is possible in a relatively short time to generate data indicating the frequency distribution of interval widths corresponding to the numerical sequence.

Moreover, the interval width setting unit 192 repeatedly changes the interval width setting until the number of the intervals is no longer estimated to be greater than the threshold value.

As a result, the frequency distribution data generation device 100 can generate frequency distribution data in which the number of intervals included in the frequency distribution data is equal to or less than the threshold value. According to the frequency distribution data generation device 100, in this respect, when generating data indicating the frequency distribution of numbers included in a numerical sequence, it is possible to generate data indicating the frequency distribution of interval widths corresponding to the numerical sequence.

If it is estimated that the number of the intervals included in the frequency distribution data at the time when all numbers included in the target numerical sequence for frequency distribution data generation are reflected is greater than the predetermined threshold value, and if it is determined that there are numbers included in the numerical sequence that are not reflected in the frequency distribution data, the frequency distribution data generation unit 193 repeats the process of reflecting numbers included in the numerical sequence that are not reflected in the frequency distribution data, in the frequency distribution data, until it is estimated that the number of the intervals included in the frequency distribution data at the time when all numbers included in the numerical sequence are reflected is greater than the predetermined threshold value, or it is determined that all numbers included in the numerical sequence are reflected in the frequency distribution data.

Thereby, the frequency distribution data generation unit 193 can determine whether or not to continue the process of reflecting in the frequency distribution data the numbers included in the numerical sequence that are not reflected in the frequency distribution data, depending on whether or not a change is needed in the interval width, and in this respect, frequency distribution data can be efficiently generated. According to the frequency distribution data generation device 100, in this respect, when generating data indicating the frequency distribution of numbers included in a numerical sequence, it is possible in a relatively short time to generate data indicating the frequency distribution of interval widths corresponding to the numerical sequence.

Moreover, the frequency distribution data generation unit 193 generates frequency distribution data that includes no intervals in which the number of numbers included in the numerical sequence is zero.

As a result, the number of intervals included in the frequency distribution data becomes relatively small. According to the frequency distribution data generation device 100, in this respect, the amount of time required for generating the frequency distribution data and the amount of time required for accessing the generated frequency distribution data are relatively short, and the memory capacity for storing the frequency distribution data is relatively small.

Moreover, the frequency distribution data generation unit 193 generates a key in frequency distribution data in the form of a hash table by means of a shift operation on a bit sequence indicating numbers in binary included in the target numerical sequence of frequency distribution data generation.

As a result, the frequency distribution data generation unit 193 can relatively easily generate keys in frequency distribution data in the form of a hash table. According to the frequency distribution data generation device 100, in this respect, it is possible in a relatively short time to generate data indicating the frequency distribution of interval widths corresponding to the numerical sequence.

Moreover, the frequency distribution data generation unit 193 generates a key in frequency distribution data in the form of a hash table by performing masking on a bit sequence indicating numbers in binary included in the target numerical sequence of frequency distribution data generation.

As a result, the frequency distribution data generation unit 193 can relatively easily generate keys in frequency distribution data in the form of a hash table. According to the frequency distribution data generation device 100, in this respect, it is possible in a relatively short time to generate data indicating the frequency distribution of interval widths corresponding to the numerical sequence.

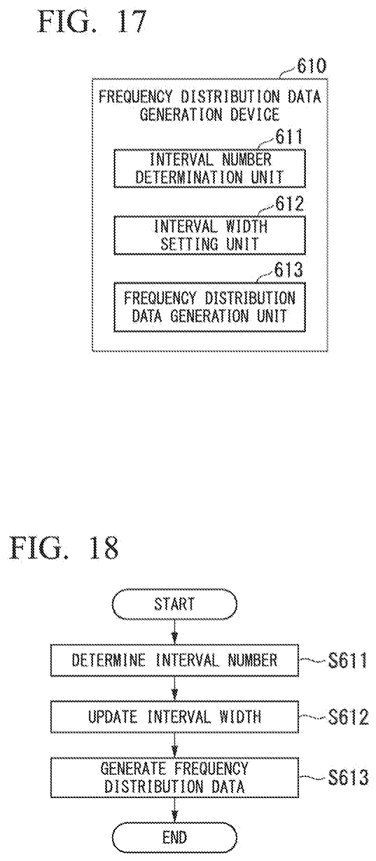

FIG. 17 is a diagram showing an example of another configuration of the frequency distribution data generation device according to some example embodiments of the present disclosure. In the configuration shown in FIG. 17, a frequency distribution data generation device 610 includes: an interval number determination unit 611, an interval width setting unit 612, and a frequency distribution data generation unit 613.

With such a configuration, the interval number determination unit 611 estimates whether or not the number of intervals included in frequency distribution data at the time when all numbers included in the target numerical sequence for frequency distribution data generation are reflected in the frequency distribution data, is greater than the predetermined threshold value. The frequency distribution data is a set of data indicating, for each interval of a set interval width, the number of numbers included in the interval among the numbers included in the numerical sequence. The interval width setting unit 612 changes the interval width setting to a wider interval width if the number of the intervals is estimated to be greater than the threshold value. The frequency distribution data generation unit 613 generates frequency distribution data, using the interval width of after the change.

The interval number determination unit 611 corresponds to an example of the interval number determination means. The interval width setting unit 612 corresponds to an example of the interval width setting means. The frequency distribution data generation unit 613 corresponds to an example of the frequency distribution data generation means.

The frequency distribution data generation device 610 can generate frequency distribution data upon determining interval widths in accordance with the trade-offs such as: the higher the number of intervals included in the frequency distribution data, the longer it will take to generate the frequency distribution data; and the lower the number of intervals included in the frequency distribution data, the more likely variation will occur in the number of numbers included in each interval. According to the frequency distribution data generation device 610, in this respect, when generating data indicating the frequency distribution of numbers included in a numerical sequence, it is possible in a relatively short time to generate data indicating the frequency distribution of interval widths corresponding to the numerical sequence.

FIG. 18 is a diagram showing an example of a processing procedure in a frequency distribution data generation method according to some example embodiments of the present disclosure. The frequency distribution data generation method shown in FIG. 18 includes: a step of determining the number of intervals (Step S611); a step of updating the interval width (Step S612); and a step of generating frequency distribution data (Step S613).

In the step of determining the number of intervals (Step S611), a computer estimates whether or not the number of intervals included in frequency distribution data at the time when all numbers included in the target numerical sequence for frequency distribution data generation are reflected in the frequency distribution data, is greater than a predetermined threshold value. The frequency distribution data is a set of data indicating, for each interval of a set interval width, the number of numbers included in the interval among the numbers included in the numerical sequence. In the step of updating the interval width (Step S612), the computer changes the interval width setting to a wider interval width if the number of the target intervals of frequency distribution data generation is estimated to be greater than the threshold value.

In the step of generating frequency distribution data (Step S613), the computer generates frequency distribution data with the changed interval width.

According to the frequency distribution data generation method shown in FIG. 18, it is possible to generate frequency distribution data upon determining interval widths in accordance with the trade-offs such as: the higher the number of intervals included in the frequency distribution data, the longer it will take to generate the frequency distribution data; and the lower the number of intervals included in the frequency distribution data, the more likely variation will occur in the number of numbers included in each interval. According to the frequency distribution data generation method shown in FIG. 18, in this respect, when generating data indicating the frequency distribution of numbers included in a numerical sequence, it is possible in a relatively short time to generate data indicating the frequency distribution of interval widths corresponding to the numerical sequence.

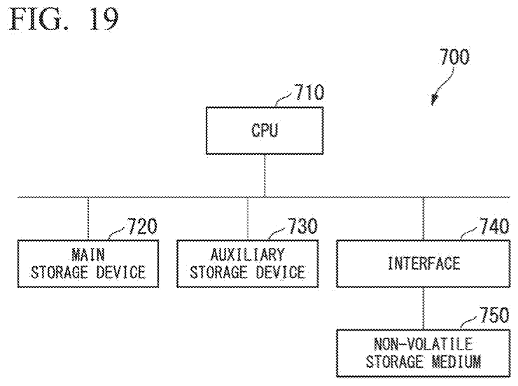

FIG. 19 is a schematic block diagram showing a configuration of a computer according to at least one of the example embodiments.

In the configuration shown in FIG. 19, a computer 700 includes a CPU 710, a primary storage device 720, an auxiliary storage device 730, an interface 740, and a non-volatile recording medium 750.

Either one or both of the frequency distribution data generation device 100 and the frequency distribution data generation device 610 or part thereof may be implemented in the computer 700. In such a case, operations of the respective processing units described above are stored in the auxiliary storage device 730 in the form of a program. The CPU 710 reads out the program from the auxiliary storage device 730, loads it on the primary storage device 720, and executes the processing described above according to the program. Moreover, the CPU 710 reserves, according to the program, storage regions corresponding to the respective storage units mentioned above, in the primary storage device 720. Communication between each device and other devices is executed by the interface 740 having a communication function and communicating under the control of the CPU 710. The interface 740 also has a port for the non-volatile recording medium 750, and reads information from the non-volatile recording medium 750 and writes information to the non-volatile recording medium 750.

In the case where the frequency distribution data generation device 100 is implemented in the computer 700, operations of the control unit 190 and each unit thereof are stored in the auxiliary storage device 730 in the form of a program. The CPU 710 reads out the program from the auxiliary storage device 730, loads it on the primary storage device 720, and executes the processing described above according to the program.

Also, the CPU 710 reserves a storage region in the primary storage device 720 for the storage unit 180, according to the program. Communication with another device performed by the communication unit 110 is executed by the interface 740 having a communication function and operating under the control of the CPU 710. Display of images performed by the display unit 120 is executed by the interface 740 having a display device and displaying various images under the control of the CPU 710. User operations are received through the operation input unit 130 by the interface 740 having an input device and receiving user operations under control of the CPU 710.

In the case where the frequency distribution data generation device 610 is implemented in the computer 700, the operations of the interval number determination unit 611, the interval width setting unit 612, and the frequency distribution data generation unit 613 are stored in the auxiliary storage device 730 in the form of a program. The CPU 710 reads out the program from the auxiliary storage device 730, loads it on the primary storage device 720, and executes the processing described above according to the program.

Moreover, the CPU 710 reserves a storage region in the primary storage device 720 for the processing to be performed by the frequency distribution data generation device 610, according to the program. Communication with other devices performed by the frequency distribution data generation device 610 is executed by the interface 740 having a communication function and operating under the control of the CPU 710. Interaction between the frequency distribution data generation device 610 and a user is executed by the interface 740 having an input device and an output device, presenting information to the user through the output device under the control of the CPU 710, and receiving user operations through the input device.

Any one or more of the programs described above may be recorded in the non-volatile recording medium 750. In such a case, the interface 740 may read the program from the non-volatile recording medium 750. Then, the CPU 710 directly executes the program read by the interface 740, or it may be temporarily stored in the primary storage device 720 or the auxiliary storage device 730 and then executed.

It should be noted that a program for executing some or all of the processes performed by the frequency distribution data generation device 100 and the frequency distribution data generation device 610 may be recorded on a computer-readable recording medium, and the program recorded on the recording medium may be read into and executed on a computer system, to thereby perform the processing of each unit. The “computer system” here includes an OS (operating system) and hardware such as peripheral devices.

Moreover, the “computer-readable recording medium” referred to here refers to a portable medium such as a flexible disk, a magnetic optical disk, a ROM (Read Only Memory), and a CD-ROM (Compact Disc Read Only Memory), or a storage device such as a hard disk built in a computer system. The above program may be a program for realizing a part of the functions described above, and may be a program capable of realizing the functions described above in combination with a program already recorded in a computer system.

The example embodiments of the present disclosure have been described in detail with reference to the drawings. However, the specific configuration of the disclosure is not limited to the example embodiments, and may include designs and so forth that do not depart from the scope of the present disclosure.

The whole or part of the example embodiments disclosed above can be described as, but not limited to, the following supplementary notes.

### Supplementary Note 1

A frequency distribution data generation device comprising:
a memory configured to store instructions; and
a processor configured to execute the instructions to:
   estimate whether or not a number of intervals that are included in frequency distribution data at a time when all numbers included in a numerical sequence are reflected, is greater than a predetermined threshold, each interval having an interval width, the frequency distribution data indicating, for each of the intervals, a number of numbers included in the interval among numbers included in the numerical sequence;
   change the interval width to a wider interval width when the number of the intervals is estimated to be greater than the threshold value; and
   generate the frequency distribution data with the changed interval width.

### Supplementary Note 2

The frequency distribution data generation device according to supplementary note 1, wherein the processor configured to execute the instructions to:
determine whether or not a number of intervals included in frequency distribution data being generated is greater than the threshold value, to whereby determines whether or not the number of the intervals that are included in the frequency distribution data at the time when all numbers included in the numerical sequence are reflected, is greater than the predetermined threshold value; and
when the number of the intervals included in frequency distribution data being generated is determined as being greater than the threshold value, stop generating the frequency distribution data having an interval width of before the change and generate the frequency distribution data having an interval width of after the change.

### Supplementary Note 3

The frequency distribution data generation device according to supplementary note 2, wherein the processor configured to execute the instructions to:
change the interval width so that all intervals of before interval width change are included in any one interval of after interval width change; and
total a number of numbers included in all intervals of the before interval width change that are included in a same interval of the after interval width change.

### Supplementary Note 4

The frequency distribution data generation device according to any one of supplementary notes 1 to 3, wherein the processor is configured to execute the instructions to repeatedly change the interval width until the number of the intervals is no longer estimated to be greater than the threshold value.

### Supplementary Note 5

The frequency distribution data generation device according to any one of supplementary notes 1 to 4, wherein the processor is configured to execute the instructions to, when it is estimated that the number of the intervals included in the frequency distribution data at the time when all numbers included in the numerical sequence are reflected is greater than the predetermined threshold value and it is determined that there is a number included in the numerical sequence that is not reflected in the frequency distribution data, repeat a process of reflecting the number included in the numerical sequence that is not reflected in the frequency distribution data, in the frequency distribution data, until it is estimated that the number of the intervals included in the frequency distribution data at the time when all numbers included in the numerical sequence are reflected is greater than the predetermined threshold value, or it is determined that all numbers included in the numerical sequence are reflected in the frequency distribution data.

### Supplementary Note 6

The frequency distribution data generation device according to any one of supplementary notes 1 to 5, wherein the processor is configured to execute the instructions to generate the frequency distribution data that includes no intervals in which the number of numbers included in the numerical sequence is zero.

### Supplementary Note 7

The frequency distribution data generation device according to supplementary note 6, wherein the processor is configured to execute the instructions to generate a key in frequency distribution data in a form of a hash table by means of a shift operation on a bit sequence indicating numbers in binary included in the numerical sequence.

### Supplementary Note 8

The frequency distribution data generation device according to supplementary note 6, wherein the processor is configured to execute the instructions to generate a key in frequency distribution data in a form of a hash table by means of masking on a bit sequence indicating numbers in binary included in the numerical sequence.

### Supplementary Note 9

A frequency distribution data generation method executed by a computer, comprising:
estimating whether or not a number of intervals that are included in frequency distribution data at a time when all numbers included in a numerical sequence are reflected, is greater than a predetermined threshold, each interval having an interval width, the frequency distribution data indicating, for each of the intervals, a number of numbers included in the interval among numbers included in the numerical sequence;
changing the interval width to a wider interval width when the number of the intervals is estimated to be greater than the threshold value; and
generating the frequency distribution data with the changed interval width.

### Supplementary Note 10

A non-transitory computer-readable recording medium that stores a program for causing a computer to execute:
estimating whether or not a number of intervals that are included in frequency distribution data at a time when all numbers included in a numerical sequence are reflected, is greater than a predetermined threshold, each interval having an interval width, the frequency distribution data indicating, for each of the intervals, a number of numbers included in the interval among numbers included in the numerical sequence;
changing the interval width to a wider interval width when the number of the intervals is estimated to be greater than the threshold value; and
generating the frequency distribution data with the changed interval width.

What is claimed is:

1. A frequency distribution data generation device comprising:
a memory configured to store instructions; and
a processor configured to execute the instructions to:
estimate whether or not a number of intervals that are included in frequency distribution data at a time when all numbers included in a numerical sequence are reflected, is greater than a predetermined threshold, each interval having an interval width, the frequency distribution data indicating, for each of the intervals, a number of numbers included in the interval among numbers included in the numerical sequence;
change the interval width to a wider interval width when the number of the intervals is estimated to be greater than the threshold value; and
generate the frequency distribution data with the changed interval width.

2. The frequency distribution data generation device according to claim 1, wherein the processor configured to execute the instructions to:
determine whether or not a number of intervals included in frequency distribution data being generated is greater than the threshold value, to whereby determines whether or not the number of the intervals that are included in the frequency distribution data at the time when all numbers included in the numerical sequence are reflected, is greater than the predetermined threshold value; and
when the number of the intervals included in frequency distribution data being generated is determined as being greater than the threshold value, stop generating the frequency distribution data having an interval width of before the change and generate the frequency distribution data having an interval width of after the change.

3. The frequency distribution data generation device according to claim 2, wherein the processor configured to execute the instructions to:
change the interval width so that all intervals of before interval width change are included in any one interval of after interval width change; and
total a number of numbers included in all intervals of the before interval width change that are included in a same interval of the after interval width change.

4. The frequency distribution data generation device according to claim 1, wherein the processor is configured to execute the instructions to repeatedly change the interval width until the number of the intervals is no longer estimated to be greater than the threshold value.

5. The frequency distribution data generation device according to claim 1, wherein the processor is configured to execute the instructions to, when it is estimated that the number of the intervals included in the frequency distribution data at the time when all numbers included in the numerical sequence are reflected is greater than the predetermined threshold value and it is determined that there is a number included in the numerical sequence that is not reflected in the frequency distribution data, repeat a process of reflecting the number included in the numerical sequence that is not reflected in the frequency distribution data, in the frequency distribution data, until it is estimated that the number of the intervals included in the frequency distribution data at the time when all numbers included in the numerical sequence are reflected is greater than the predetermined threshold value, or it is determined that all numbers included in the numerical sequence are reflected in the frequency distribution data.

6. The frequency distribution data generation device according to claim 1, wherein the processor is configured to execute the instructions to generate the frequency distribution data that includes no intervals in which the number of numbers included in the numerical sequence is zero.

7. The frequency distribution data generation device according to claim 6, wherein the processor is configured to execute the instructions to generate a key in frequency distribution data in a form of a hash table by means of a shift operation on a bit sequence indicating numbers in binary included in the numerical sequence.

8. The frequency distribution data generation device according to claim 6, wherein the processor is configured to execute the instructions to generate a key in frequency distribution data in a form of a hash table by means of masking on a bit sequence indicating numbers in binary included in the numerical sequence.

9. A frequency distribution data generation method executed by a computer, comprising:
estimating whether or not a number of intervals that are included in frequency distribution data at a time when all numbers included in a numerical sequence are reflected, is greater than a predetermined threshold, each interval having an interval width, the frequency distribution data indicating, for each of the intervals, a number of numbers included in the interval among numbers included in the numerical sequence;
changing the interval width to a wider interval width when the number of the intervals is estimated to be greater than the threshold value; and
generating the frequency distribution data with the changed interval width.

10. A non-transitory computer-readable recording medium that stores a program for causing a computer to execute:
estimating whether or not a number of intervals that are included in frequency distribution data at a time when all numbers included in a numerical sequence are reflected, is greater than a predetermined threshold, each interval having an interval width, the frequency distribution data indicating, for each of the intervals, a number of numbers included in the interval among numbers included in the numerical sequence;
changing the interval width to a wider interval width when the number of the intervals is estimated to be greater than the threshold value; and
generating the frequency distribution data with the changed interval width.
